(19) United States
(12) Patent Application Publication
(10) Pub. No.: US 2006/0277575 A1
(43) Pub. Date: Dec. 7, 2006

(54) Method for providing an electronic program guide using icons in a digital multimedia broadcasting system

(75) Inventors: Byoung-Dai Lee, Seongnam-si (KR); Young-Jip Kim, Suwon-si (KR); Hyun-Chul Kim, Suwon-si (KR); Ji-Wuck Jung, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/446,942

(22) Filed: Jun. 5, 2006

(30) Foreign Application Priority Data
Jun. 7, 2005 (KR) 48290/2005

(51) Int. Cl. H04N 5/445; G06F 13/00; G06F 3/00; H04N 7/16

(52) U.S. Cl. 725/45; 725/39; 725/52; 725/53; 725/62; 725/56

(57) ABSTRACT

A method for providing Electronic Program Guide (EPG) information using icons in a Digital Multimedia Broadcasting (DMB) receiver of a DMB system includes: receiving DMB data and extracting EPG information by the DMB receiver, dividing the extracted EPG information according to a broadcasting channel and classifying the divided EPG information according to a service type of each broadcasting channel, and outputting the EPG information including icons assigned to broadcasting channels according to service types.

### CLAIM OF PRIORITY

This application claims priority under 35 U.S.C. § 119 to an application entitled “Method for Providing an Electronic Program Guide Using Icons in a Digital Multimedia Broadcasting System” filed in the Korean Intellectual Property Office on Jun. 7, 2005 and assigned Ser. No. 2005-48290, the contents of which are incorporated herein by reference.

### BACKGROUND OF THE INVENTION

1. Field of the Invention

The present invention generally relates to a Digital Multimedia Broadcasting (DMB) receiver, and in particular, to a method for providing Electronic Program Guide (EPG) information in a DMB receiver.

2. Description of the Related Art

Digital Multimedia Broadcasting (DMB) is a broadcasting service which provides various multimedia signals, such as audio or video signals, to a portable or vehicle receiver in a digital format. The DMB is also classified into satellite DMB and terrestrial DMB according to its transmission medium types. The satellite DMB transmits programs to DMB terminals through satellite waves, and the terrestrial DMB transmits broadcasting using sky-wave VHF channels 12 and 8.

FIG. 1 illustrates a general satellite DMB system. As shown, the satellite DMB system includes a DMB broadcasting center 11 for converting broadcasting contents into broadcasting signals (i.e., Code Divisional Multiplexing (CDM) and Time Divisional Multiplexing (TDM) broadcasting signals) to provide the broadcasting contents to users, a DMB broadcasting sending center 12 for sending broadcasting signals received from the DMB broadcasting center 11 to a DMB satellite 13, which in turn, re-transmits the broadcasting signals received from the DMB broadcasting sending center 12, a DMB mobile terminal 114 for outputting the received broadcasting signals to users, a vehicle mounted terminal 15, and a gap filler 16 for re-transmission in shadow areas.

The DMB broadcasting sending center 12 transmits broadcasting signals to the DMB satellite 13 through a Ku-band (13 GHz), and in return, the DMB satellite 13 transmits CDM signals in a circularly polarized wave form to satellite DMB receivers, i.e., the DMB mobile terminal 14 and the vehicle mounted terminal 15 through an S-band (2.6 GHz).

The DMB satellite 13 also transmits TDM signals in a linearly polarized wave form to the gap filler 16 through a Ku-band (12 GHz). The gap filler 16 converts the TDM signals in the linearly polarized form into CDM signals in the circularly polarized wave form and transmits the CDM signals to the DMB mobile terminal 14 and the vehicle mounted terminal 15 through the S-band (2.6 GHz). Note that the gap filler 16 is used to send signals to shadow areas which satellite signals cannot reach.

The satellite DMB system is supposed to provide several tens of broadcasting channels to users. To provide program information for multiple channels and enable users to navigate programs, the satellite DMB system provides an Electronic Program Guide (EPG). The EPG, which is provided with broadcasting signals, enables a user to easily access a desired broadcasting program by displaying a broadcasting schedule on the screen of a digital TV.

A current satellite DMB system assigns a separate Elementary Stream (ES) in a Motion Picture Experts Group (MPEG) Transport Stream (TS) during the transmission of EPG data. A Program ID (PID) of the ES can be acquired from a Program Mapping Table (PMT) of the MPEG TS. Data required for configuring the EPG in the satellite DMB system, i.e., “a service name and time information of a service”, is transmitted through a Service Description Table (SDT) and an Event Information Table (EIT) of the MPEG TS.

A DMB service is classified into audio/video/data services according to the type of a main service. In a conventional EPG, the audio/video/data services are separately displayed.

FIGS. 2A and 2B illustrate an example of an EPG provided in a conventional satellite DM1 terminal.

If an EPG is requested, the satellite DM1 terminal requests a user to select a desired service category such as “1. Video, 2. Audio, 3. Data” as illustrated in FIG. 2A and also provides channel information for each category as illustrated in FIG. 2B. The channel information includes a broadcasting service name and a broadcasting service providing time for each channel.

An EPG is provided for each service category for user's convenience since the user cannot know that broadcasting corresponding to which service category is provided due to an increase in the number of channels. However, when conducting a search with respect to radio broadcasting, data broadcasting, and video broadcasting, users may feel inconvenience as they must repeat category-based searches and changes the operation modes between categories.

In the case of audio broadcasting and video broadcasting, a main service and a data service linked thereto can be transmitted simultaneously. For example, when an audio-linked data service are provided, such as Dynamic Label Segments (DLS) or Slide Show (SLS) linked with an audio service and a video service, audio and video services and a Java application program linked thereto can be transmitted simultaneously using Java based DMB middleware.

However, in a conventional DMB receiver, the EPG merely shows a service name and its related time information by analyzing the SDT and the EIT and, when a data service is additionally provided together with a main service as mentioned above, the user must check if the additional data service is actually provided after selecting a corresponding service.

### SUMMARY OF THE INVENTION

The present invention to provide a method for providing an EPG using icons in a DMB system to provide text information of a conventional EPG and information according to a service type to allow users to readily enjoy the desired content.

One aspect of the present invention is to improve user's convenience by displaying a data service included in a main service through an EPG in a DMB system.

In one embodiment, there is provided a method for providing EPG information using icons in a DMB receiver of a DMB system. The method includes a step of receiving DMB data and extracting EPG information by the DMB receiver, a step of dividing the extracted EPG information according to a broadcasting channel and classifying the divided EPG information according to a service type of each broadcasting channel, and a step of outputting the EPG information including icons assigned to broadcasting channels according to service types.

### BRIEF DESCRIPTION OF THE DRAWINGS

The above features and advantages of the present invention will become more apparent from the following detailed description when taken in conjunction with the accompanying drawings in which:

FIG. 1 illustrates a general satellite DMB system;

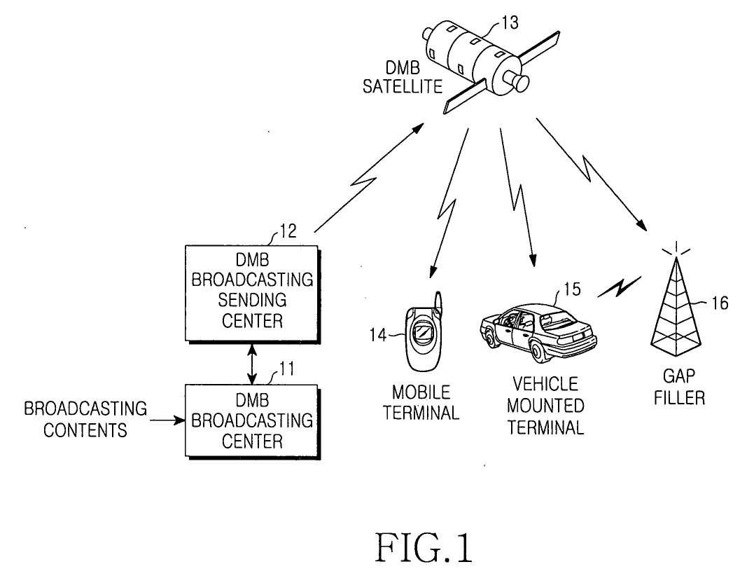

FIGS. 2A and 2B illustrate an example of an EPG provided in a conventional satellite DMB terminal;

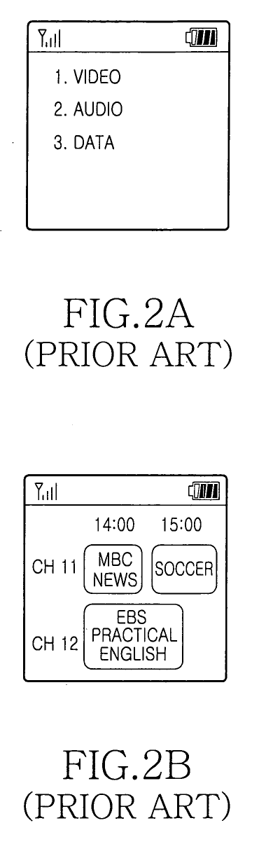

FIG. 3 is a flowchart illustrating a method for displaying EPG information in a DMB terminal according to the present invention; and

FIGS. 4A and 4B illustrate EPGs provided in a conventional DMB receiver and an EPG provided using icons in a DMB receiver according to the present invention.

### DETAILED DESCRIPTION OF THE INVENTION

An embodiment of the present invention will now be described in detail with reference to the annexed drawings. For the purposes of clarity and simplicity, a detailed description of known functions and configurations incorporated herein has been omitted for conciseness.

According to the teachings of the present invention, to solve the inconvenience of separately displaying EPG information according to a service type (audio, video, or data) as in a conventional DMB, EPG information for the entire channels is displayed simultaneously according to a predetermined format. In particular, a service type for each of the channels is marked with an icon, which identified the service type amongst different media content. That is, when an icon is assigned to a broadcasting service according to a service type, program-linked data broadcasting is additionally marked, thereby allowing a user to previously know the presence of additional data broadcasting and the type of the additional data broadcasting in a corresponding channel even if the user does not directly select a service.

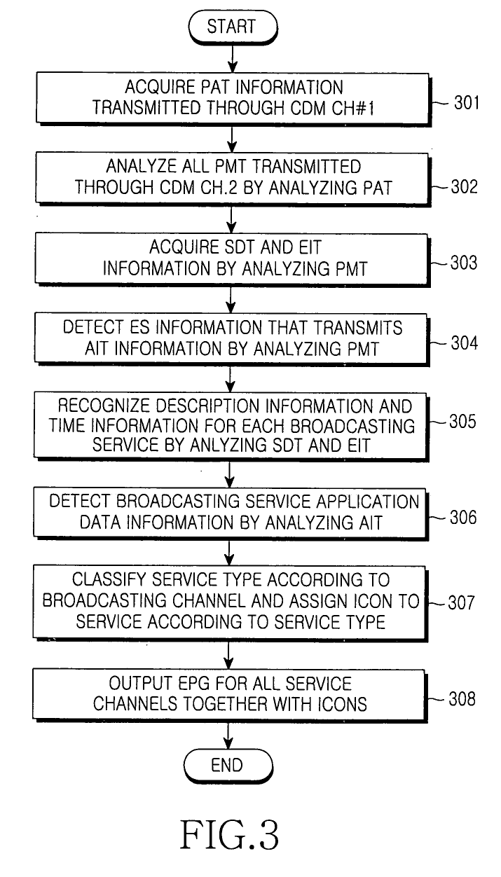

FIG. 3 is a flowchart illustrating a method of displaying EPG information in a DMB terminal according to the embodiment of the present invention.

Referring to FIG. 3, the DMB terminal acquires Program Access Table (PAT) information transmitted through a Code Divisional Multiplexing (CDM) channel 1 in step 301.

The DMB terminal then analyzes the PAT information to analyze all Program Mapping Table (PMT) information transmitted through a CDM channel 2 in step 302.

The DMB terminal acquires Service Description Table (SDT) and Event Information Table (EIT) information through the analyzed PMT information in step 303.

Here, the SDT information includes text information for transmitting channel information or indicating program guide information. In other words, when a corresponding channel is paid for or subscribed by a viewer, the cost for receiving the corresponding channel and a guide for the next program are inserted into the SDT information, such that when program information for a movie is displayed, a short description of the movie is inserted into the SDT information.

The EIT information is used to provide program guide information based on a time zone, and a single EIT includes program guide information corresponding to 3 hours. A total of 128 EITs can be used and a broadcasting station can advertise program guide information corresponding to a maximum of 16 days using the 128 EITs. If EIT-0 includes program guide information corresponding to 3 hours later from the current time, EIT-1 includes program guide information corresponding to the next 3 hours. Each transport packet includes at least four EITs. In other words, since EIT-0, EIT-1, and EIT-2 include guide tables corresponding to their time zones and a table of EIT-x refers to EIT-0, EIT-1, and EIT-2 for a desired broadcasting program using Source_id with guide information for each broadcasting program or element stream, program guide information of corresponding broadcasting for each time zone can be provided.

The DMB terminal detects Elementary Stream (ES) information that transmits Application Information Table (AIT) information through the analyzed PMT information in step 304.

Here, the AIT information is used to additionally display application program information and includes information indicating whether an application program is included in each broadcasting service and position information of the application program.

The DMB terminal analyzes the acquired SDT and EIT information to recognize description information and time information for each DMB broadcasting service in step 305.

According to the detected ES information, the DMB terminal analyzes the AIT information included in the ES information to detect application data information included in a corresponding DMB broadcasting service in step 306.

Each broadcasting service is classified according to a service type based on the detected EPG information and a preset icon corresponding to a service type is assigned to a corresponding broadcasting service in step 307.

EPG information for all DMB broadcasting channels received through the DM1 terminal is output together with assigned icons in step 308.

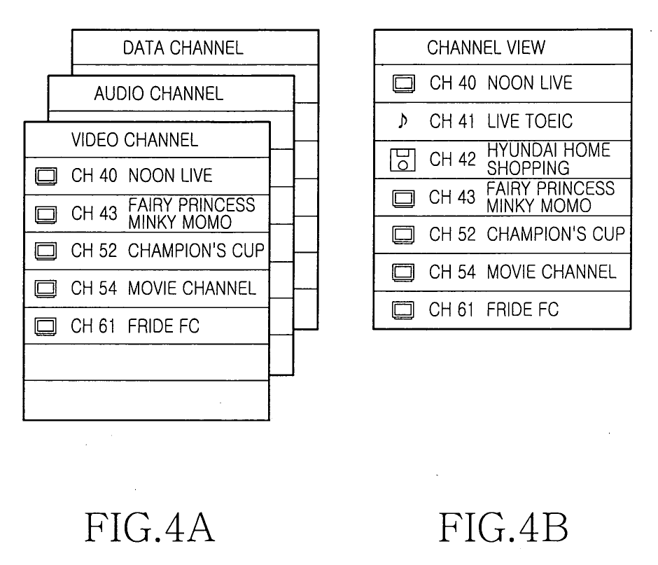

FIGS. 4A and 4B illustrate EPGs provided in a conventional DMB receiver and an EPG provided using icons in a DMB receiver according to the present invention.

Unlike EPGs provided for service types in the conventional DMB receiver as illustrated in FIG. 4A, an EPG provided in a DMB receiver according to the present invention shows the entire channel information on a single screen and marks service types with icons matching the type of media content as illustrated in FIG. 4B.

As such, by providing an EPG in which each service type is marked with an icon that distinguishes media type, a user can recognize the entire serviced channel information at a glance and see service type information for each channel. In addition, when additional application program information is included in a broadcasting service in FIG. 4B, it is marked with an icon so that its information can also be displayed according to its service type. For example, an audio service is marked with an icon “A” or “ [symbol] ”, a video service is marked with an icon “V” or “a TV-like image”, and an independent data service is marked with an icon “D” or “a disc-like image” on the screen.

Note that if these icons are not marked as in FIG. 4B, the user does not know whether a broadcasting service whose service name is “News” is a video service or an audio service. In the prior art, the user knew only after directly selecting and then receiving the broadcasting service. That is, to know whether an additional data service is provided through a broadcasting service whose service name is “Sports”, the user must directly select the broadcasting service. However, in the present invention, the user can know in advance that the broadcasting service is an audio service and an additional data service is also provided through the broadcasting service by seeing an icon (e.g., “A/D” or “ [symbol] ” a disc-like image) assigned to the broadcasting service without directly selecting the broadcasting service.

As described above, according to the present invention, by providing detailed information about a broadcasting service through not only text information but also icons in an EPG, the user can easily recognize the type of the broadcasting service, thus it is not necessary to provide EPGs separately for each service type. Moreover, when an additional data service is provided through a broadcasting service, information about the data service is displayed with an icon, thereby allowing the user to know the presence of the data service in the broadcasting service and the type of the data service in advance without directly selecting the broadcasting service.

While the present invention has been shown and described with reference to a preferred embodiment thereof, it will be understood by those skilled in the art that various changes in form and details may be made therein without departing from the spirit and scope of the invention.

What is claimed is:

1. A method for providing Electronic Program Guide (EPG) information using icons in a Digital Multimedia Broadcasting (DMB) receiver of a DMB system, the method comprising:
a first step of receiving DMB data and extracting the EPG information by the DMB receiver;
a second step of dividing the extracted EPG information according to a broadcasting channel and classifying the divided EPG information according to a service type for each broadcasting channel; and
a third step of outputting the EPG information including icons corresponding to broadcasting channels according to service types.

2. The method of claim 1, wherein the service type of each broadcasting channel is one of a video service, an audio service, and a data service.

3. The method of claim 1, wherein the service type of each broadcasting channel is one of a video service, an audio service, a data service, an audio service including application data, and a video service including application data.

4. The method of claim 3, wherein in the audio service including the application data and the video service including the application data, information about the application data includes the type and position of the application data through Application Information Table (AIT) information of the EPG information extracted in the first step.

5. The method of claim 1, wherein the first step comprises:
receiving the DMB data and acquiring Program Access Table (PAT) information through a predetermined Code Divisional Multiplexing (CDM) channel by the DMB receiver;
analyzing the PAT information to analyze all Program Mapping Table (PMT) information transmitted through a second CDM channel;
acquiring Service Description Table (SDT) for displaying description information for each DMB broadcasting service and Event Information Table (EIT) information for displaying time information for each DMB broadcasting service through the analyzed PMT information;
detecting information about an Elementary Stream (ES) that transmits Application Information Table (AIT) information including information about an application program through the analyzed PMT information;
recognizing the description information for each DMB broadcasting service and the time information for each DMB broadcasting service by analyzing the acquired SDT and EIT information; and
detecting application data information included in a DMB broadcasting service by analyzing the AIT information included in the ES according to the information about the detected ES.

6. The method of claim 1, wherein the DMB receiver is a satellite DMB receiver

7. The method of claim 1, wherein the DMB receiver is a terrestrial DMB receiver.

8. A method for providing Electronic Program Guide (EPG) information using icons in a Digital Multimedia Broadcasting (DMB) receiver of a DMB system, the method comprising:
upon receiving a broadcasting signal, extracting the EPG information by the DMB receiver;
classifying the extracted EPG information according to a broadcasting channel and according to a service type to each broadcasting channel; and
displaying the EPG information including icons corresponding to broadcasting channels according to service types.

9. The method of claim 8, wherein the service type of each broadcasting channel is one of a video service, an audio service, and a data service.

10. The method of claim 8, wherein the service type of each broadcasting channel is one of a video service, an audio service, a data service, an audio service including application data, and a video service including application data.

11. The method of claim 8, wherein the DMB receiver is a satellite DMB receiver

12. The method of claim 8, wherein the DMB receiver is a terrestrial DMB receiver.
